(19) United States
(12) Patent Application Publication
(10) Pub. No.: US 2026/0168537 A1
(43) Pub. Date: Jun. 18, 2026

(54) BEARING ASSEMBLY WITH AT LEAST ONE BRUSH ASSEMBLY AND METHOD FOR ASSEMBLING A BEARING ASSEMBLY

(71) Applicants: AKTIEBOLAGET SKF, GOTEBORG (SE); SKF Aerospace France S.A.S, Perrigny (FR)

(72) Inventors: Benoit ARNAULT, Saint-Cyr-sur-Loire (FR); Franck GERVAIS, Bourg de Péage (FR)

(21) Appl. No.: 19/395,333

(22) Filed: Nov. 20, 2025

(30) Foreign Application Priority Data
Dec. 13, 2024 (DE) 102024137559.0

(51) Int. Cl. F16C 41/00; F16C 33/06; F16C 33/58

(52) U.S. Cl. CPC F16C 41/002; F16C 33/06; F16C 33/583

(57) ABSTRACT

A bearing assembly has at least one brush assembly, which includes a first part fixed to a bearing ring of the bearing assembly, a second part fixed to the first part, and a conductive brush fixed to the second part. The first part abuts against a first, face side of the second part and also buts a second, opposing side of the second part.

### CROSS-REFERENCE

This application claims priority to German patent application no. 102024137559.0 filed on Dec. 13, 2024, the contents of which are fully incorporated herein by reference.

### BACKGROUND OF THE INVENTION

The present invention relates to bearings, and more particularly to a bearing assembly with at least one grounding brush assembly, a device with a housing and a bearing assembly and a procedure for assembling a bearing assembly.

German patent no. 10 2021 205 177 A1 discloses a generic bearing assembly with a brush assembly. Moreover, German patent nos. 10 2021 203 004 A1 and 10 2021 205 176 A1 describe further bearing assemblies with grounding brushes. Furthermore, Korean patent no. 20240066730A, European patent no. 4 446 602 A1 and German patent no. 10 2023 110 736 A1 describe other bearings which each comprise conductive means for protecting the bearings from electrical current.

The problem to be solved by the present invention is in particular to provide a simple and safe fixation of a conductive brush.

### SUMMARY OF THE INVENTION

The problem noted above is solved by the present invention, which is directed to a bearing assembly with at least one brush assembly, which comprises a first part, which is fixed to a bearing ring of the bearing assembly, at least a second part, which is fixed to the first part, and a conductive brush, which is fixed to the second part, wherein the first part abuts against a first side of the second part, which is a face side of the second part.

It is proposed that the first part abuts against a second side of the second part, which is located opposite to the first side. Through this a simple and safe fixation of the conductive brush can be achieved. In particular, it can be achieved that an assembly of the brush assembly can take place at a relatively large distance from a shaft, which can be supported rotatably by the bearing assembly.

With advantage the first part comprises at least a first radially-extending portion, which abuts against a face side of the bearing ring. Under a “radially-extending portion” in particular a portion is supposed to be understood, which in an axial section through the bearing assembly comprises a longitudinal direction, which includes an angle with a radial direction of the bearing ring, which is smaller than 30°, preferably smaller than 20° and most preferably smaller than 5°. Under “axial” in particular axial with respect to the bearing ring is supposed to be understood. Through this the brush assembly can receive a relatively large force in an axial direction towards the bearing ring without being moved.

Moreover, it is suggested that the first radially-extending portion abuts against the face side of the second part. Thereby the second part can transfer relatively big forces in the axial direction towards the bearing ring without being moved.

Advantageously, the first part comprises at least a second radially-extending portion, which adjoins the first radially-extending portion and which abuts against the second side of the second part. Through this a simple and stable fixation of the second part can be reached.

With advantage the first part is integrally formed and consists of sheet metal and/or the second part is integrally formed and consists of sheet metal. Thereby a simple, cost-effective and electrically conductive construction can be achieved.

Furthermore, it is proposed that the first part is fixed to the bearing ring at least by means of a recess of the bearing ring and/or the second part is fixed to the bearing ring at least by means of the recess of the bearing ring. Thereby a compact and efficient construction can be achieved. In particular, a radial dimension of the bearing ring doesn't need to be extended for a fixation of the flange and a recess, which can be produced very cost efficiently, can be used for the fixation of the flange.

In an advantageous embodiment of the invention the recess is a groove and the first part is fixed at the bearing ring by means of a collar portion of the first part, which extends into the groove and which touches a surface of the groove. Through this a simple and non-destructively detachable fixation of the first part and a usability of a standard bearing ring, which is already produced in large quantities, can be achieved. In particular, the groove can be a ring groove.

With advantage the second part comprises at least a first fixation means, which at least contributes to a fixation of the conductive brush to the second part, and a first radially-extending portion, which has a bigger radial extent than the first fixation means, and a second radially-extending portion, which has an axial distance from the first radially-extending portion and which is located radially outwardly from the first radially-extending portion. Through this it can be achieved that the second radially-extending portion provides a possibility for a fixation to the first part at a relatively large distance to a shaft, which can be rotatably supported by the bearing assembly.

Advantageously the brush assembly abuts against the housing. Through this it can be avoided that a certain amount of electric current flows from the housing through the bearing ring.

Moreover, a procedure for assembling a bearing assembly, in particular a bearing assembly as described in the preceding text, is proposed, wherein the bearing assembly comprises a brush assembly and a face side of a second part of the brush assembly is brought into contact with a first part of the brush assembly and at least a portion of the first part is bent radially inwardly such that it touches the second part at a side of the second part, which is located opposite to the face side. Through this a simple and safe fixation of a conductive brush can be achieved. In particular, it can be achieved that an assembly of the brush assembly can take place at a relatively large distance from a shaft, which can be supported rotatably by the bearing assembly.

### BRIEF DESCRIPTION OF THE SEVERAL VIEWS OF THE DRAWINGS

Further advantages can be seen in the following description of the drawings. Examples of embodiments of the invention are shown in the drawings. The drawings, the description and the claims contain numerous features in combination. The skilled person will expediently also consider the features individually and combine them to form useful further combinations.

FIG. 1 shows a part of an axial section through a bearing assembly according to the invention;

FIG. 2 shows another part of an axial section through a bearing assembly according to the invention;

FIG. 3 shows a perspective view of the bearing assembly;

FIG. 4 shows a partially exploded view of the bearing assembly;

FIG. 5 shows a state during an assembly of the bearing assembly;

FIG. 6 shows a part of an axial section through a second embodiment of a bearing assembly according to the invention;

FIG. 7 shows another part of an axial section through the second embodiment;

FIG. 8 shows a perspective view of the second embodiment;

FIG. 9 shows a partially exploded view of the second embodiment; and

FIG. 10 shows a state during an assembly of the second embodiment.

### DETAILED DESCRIPTION OF THE INVENTION

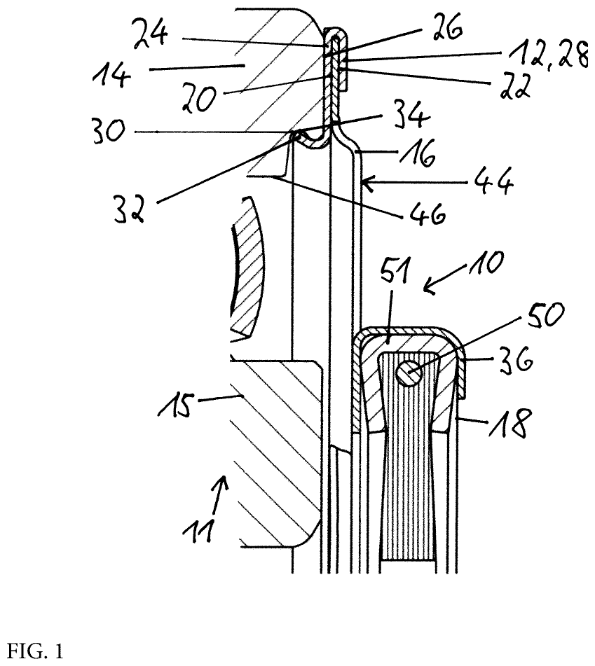

FIG. 1 shows a part of an axial section through a bearing assembly according to the invention, which comprises a bearing 11 and a brush assembly 10. A first bearing ring 14, which is an outer ring, and a second bearing ring 15, which is an inner ring, are part of the bearing 11 and are rotatable relative to each other around an axis (not shown). In the following “axial” will always refer to an axial direction with respect to the axis unless indicated otherwise. Also, in the following “radial” will always refer to a radial direction with respect to the axis unless indicated otherwise.

The bearing 11 is a rolling bearing but could alternatively be a plain bearing. Moreover, the bearing 11 is preferably a deep groove ball bearing. It is conceivable that the bearing 11 is a different kind of rolling bearing, such as for example, a cylindrical roller bearing, a taper roller bearing, a needle bearing, etc.

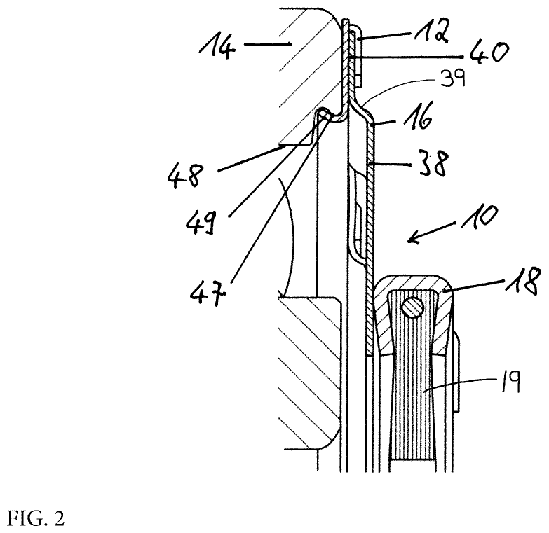

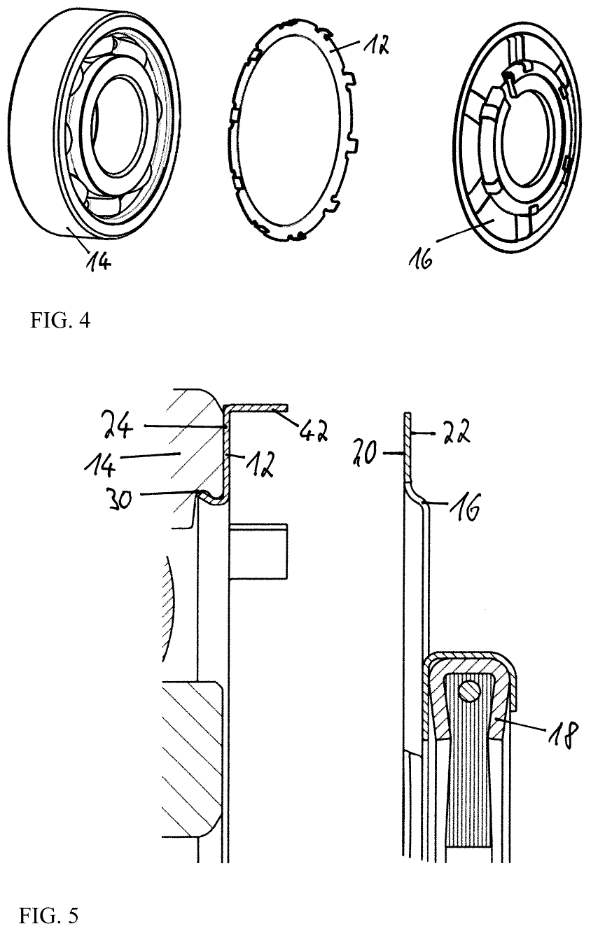

The brush assembly 10 includes a first part 12, a second part 16 and a conductive brush 18 (FIGS. 1 to 4), which is fixed to the second part 16. The second part 16 is fixed to the first part 12 and the first part 12 is fixed to the bearing ring 14. The bearing ring 14 has a recess 30, which is located on a radially inner side 46 of the bearing ring 14 and which is formed as an annular groove, which extends in a shape of a ring around the axis. An axial end 47 of the recess 30 has a radial distance from a radially-innermost inner surface area 48 of the bearing ring 14, which is greater than zero (FIG. 2).

A first radially-extending portion 24 of the first part 12, which extends radially in particular in an axial section of the bearing assembly, touches and abuts against a face side 26 of the bearing ring 14. The first radially-extending portion 24 abuts against a first axial side 20 of the second part 16, which is a face side of the second part 16. A second radially-extending portion 28 of the first part 12, which extends radially in particular in an axial section of the bearing assembly and which adjoins the first radially-extending portion 24, abuts against a second axial side 22 of the second part 16. The second side 22 is located opposite to the first side 20. Each one of the first part 12 and the second part 16 are made in one piece and formed integrally and consist of sheet metal.

The first part 12 also includes a collar portion 32, the collar portion 32 and the first radially-extending portion 24 extending 360° around the axis of the bearing 11. The second radially-extending portion 28 preferably includes a plurality of separate portions 28 of the first part 12, which are identical in construction with each other the portion 28 and which each abut against the second side 22 of the second part 16. Alternatively, each one of the plurality of portions 28 can have a shape different than the other portions 28. The plurality of portions 28 are spaced circumferentially apart from each other. Furthermore, the plurality of portions 28 fix the second part 16 in a form-fit way to the first part 12.

The first part 12 is fixed in a form-fit way to the bearing ring 14 by means of the recess 30 and by means of the collar portion 32 of the first part 12, which is preferably a clip 49. The collar portion 32 extends into the recess 30 and touches or contacts a surface 34 of the recess 30. Starting from radially-extending portion 24, the collar portion 32 extends in an axial direction away from the second part 16 and is curved radially outwardly, such that an axial end of the collar portion 32, which faces away from the second part 16, touches/contacts the surface 34 of the recess 30. With this structure, the brush assembly 10 can be detached in a nondestructive way from the bearing 11 by pulling the brush assembly 10 axially away from the bearing ring 14, such that the axial end of the collar portion 32 bends radially inwardly and can be pulled out of the recess 30.

The second part 16 includes a first radially-extending portion 38 and a second radially-extending portion 40, which is spaced or offset axially from the first radially-extending portion 38 and is located radially outwardly from the first radially-extending portion 38. The first portion 38 and the second portion 40 are connected by an intermediate portion 39, which extends both axially and radially. Collectively, the intermediate portion 39, the first portion 38, the second portion 40 and the first part 12 provide a flange 44 of the brush assembly 10. Moreover, the second part 16 further includes a first fixation means 36, which is preferably formed as a clip and which at least partially fixes or attaches the conductive brush 18 to the second part 16. The first radially-extending portion 38 has a greater radial extent or dimension than the first fixation means 36.

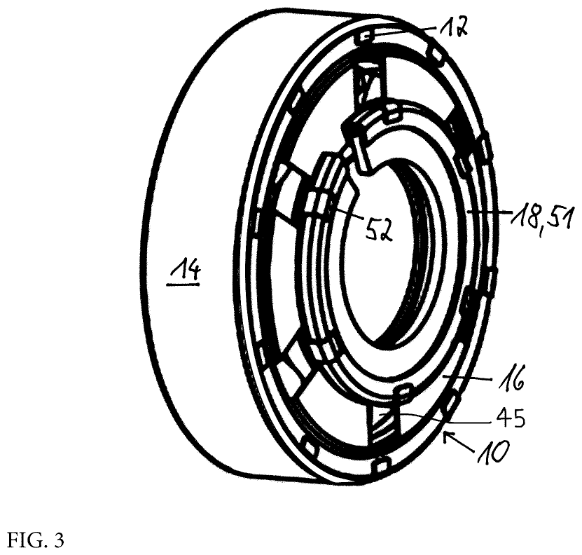

The conductive brush 18 includes conductive filaments 19 and has the shape of a ring segment, which is preferably almost an entire ring. The filaments 19 can be fibers. All the filaments 19 of the conductive brush 18 are fixed with the help of a wire 50 to a carrier element 51 of the conductive brush 18. The carrier element 51 has also the shape of a ring segment, and preferably almost an entire ring. In an axial section (FIG. 1), the carrier element 51 is U-shaped, wherein ends of the carrier element 51 are bent toward each other such that they press together the filaments 19 of the conductive brush 18, which results in a fixation of the filaments 19 to the carrier element 51. The fixation means 36 of the second part 16 preferably include a plurality of clips 52 (FIG. 3) that are each bent around the carrier element 51 such that the carrier element 51 is fixed to the second part 16 by clamping. Radially outwardly of the fixation means 36 and the clips 52, the flange 44 includes clearance holes 45 (FIG. 3). In particular, the holes 45 allow the passage of oil through the brush assembly 10, both into and out of the bearing 11. The clips 52 of the fixation means 36 are spaced from each other in a circumferential direction of the bearing axis. In total, the filaments 19 of the conductive brush 18 are connected by the carrier element 51, the second part 16 and the first part 12 to the bearing ring 14 in an electrically conductive way.

In a procedure for assembling the bearing assembly, the first part 12 includes a portion 42 which initially extends in a longitudinal direction, parallel to an axial direction of the bearing ring 14, as shown in FIG. 5. The first or face side 20 of the second part 16 is brought into contact with the first part 12. Afterward, the portion 42 of the first part 12 is bent radially inwardly such that it touches or contacts the second part 16 at the second side 22. After the portion 42 is bent, it provides the second radially-extending portion 28 of the first part 12, which is then fixed to the second part 16. A plurality of portions of the first part 12, which can be identical in construction with the portion 28, are fixed to the second part 16 in the same way as the portion 28.

The bearing ring 14 is preferably a standard bearing ring of a deep-groove ball bearing, which is already produced in very high numbers and is therefore available very cost-effectively. Such a standard bearing ring is typically provided with a groove that is used for fixing a seal for sealing a space within the bearing 11 in which balls of the deep groove ball bearing are located. The bearing assembly can be part of a device in which the bearing 11 is disposed within oil surrounding the bearing 11 and doesn't require sealing.

The purpose of the conductive brush 18 is to prevent the passage of electrical current through the bearing 11.

Since the bearing assembly is provided as a single unit consisting of the brush assembly 10 and the bearing 11, instead two or more separate units or components, only one unit has to be handled, for example, by a purchaser or end user of the bearing assembly 10.

Conductivity values of the brush 18 and the brush assembly 10 are the same.

A thickness of the first part 12 and a thickness of the second part 16 are less than a thickness of a fixation part typically used to fix or attach a conductive brush directly to a housing. Therefore, the present brush assembly 10 has a lesser weight than previously known brush assemblies.

Moreover, stamping and cutting operations for producing the brush assembly 10 are as simple as used to produce brush assemblies of the prior art. Furthermore, the bearing assembly according to the present invention requires relatively minimal installation space in both an axial and radial direction.

The bearing ring 14 preferably has an ingress chamfer (not indicated) axially in front of the recess 30, such that the brush assembly 10 can be assembled to the bearing ring 14 in a relatively easy manner.

The brush 18 can contact a shaft, which is rotatably supported by the bearing 11, and/or the inner ring of the bearing 11 and/or a part fixed to the inner ring.

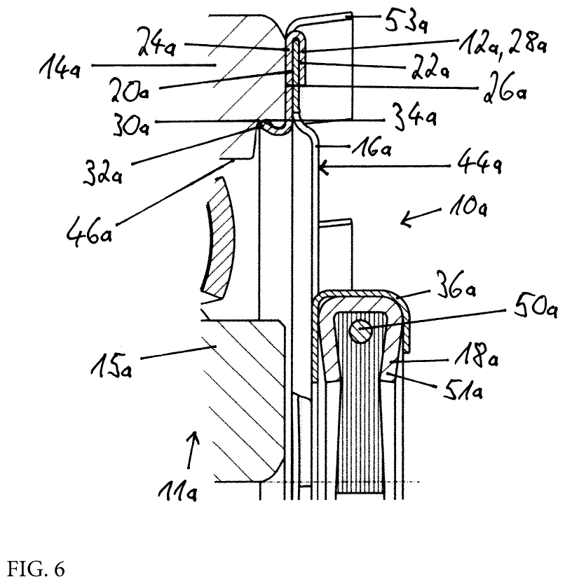

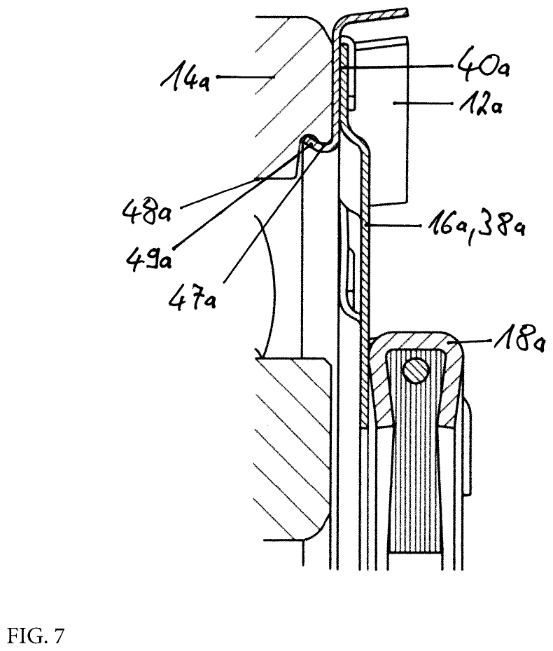

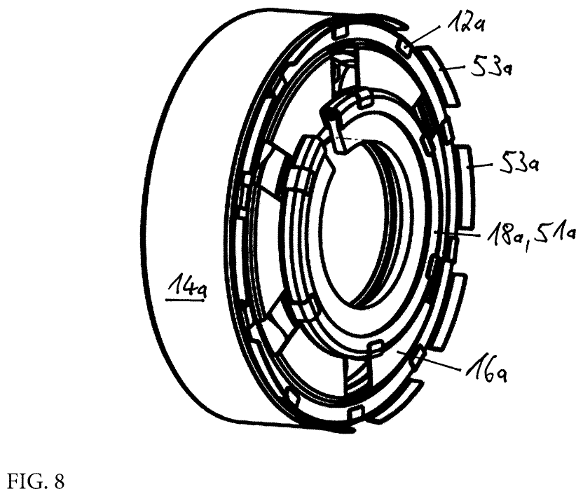

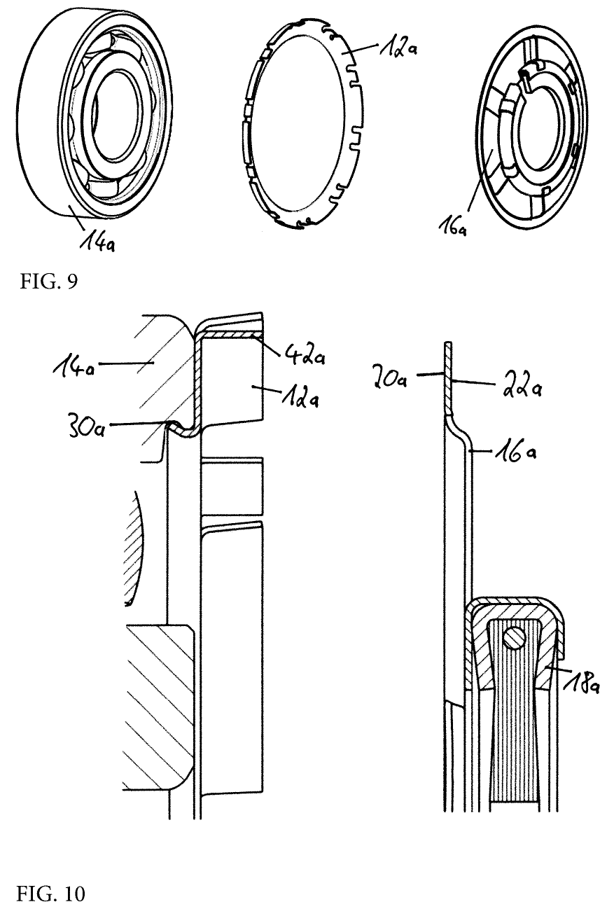

FIGS. 6-10 shows an alternative embodiment. Components, features and functions that are essentially the same are generally numbered with the same reference numerals. However, the letter “a” has been added to the reference numerals of the embodiment in FIGS. 6-10 to differentiate between the embodiments. The following description is essentially limited to the differences to the embodiment shown in FIGS. 1-5, whereby reference can be made to the description of the embodiment in FIGS. 1-5 with regard to components, features and functions that remain the same.

The primary difference of the embodiment of the FIGS. 6-10 from the embodiment of the FIGS. 1-5 is that the first part 12a includes portions 53a which are located at a radially outer end of the first part 12 and which extend both axially and radially. In a state in which a bearing assembly of FIGS. 6-10 is a part of a device including a housing, the portions 53a can abut against the housing and can thereby create an electrically conductive connection between the first part 12 and the housing. Through this connection, electric current can flow through the brush assembly 10a of the bearing assembly. A flow of electrical current from the housing through a bearing 11a can be at least partially avoided. The portions 53a are spaced from each other in a circumferential direction of the first part 12. By providing the portions 53a, an outer ring of the bearing 11a does not need to be press fit within the housing.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

List of reference numerals:

| | |
|---|---|
| 10 | brush assembly |
| 11 | Bearing |
| 12 | Part |
| 14 | bearing ring |
| 15 | bearing ring |
| 16 | Part |
| 18 | Brush |
| 20 | Side |
| 22 | Side |
| 24 | Portion |
| 26 | face side |
| 28 | Portion |
| 30 | Recess |
| 32 | collar portion |
| 34 | Surface |
| 36 | fixation means |
| 38 | Portion |
| 40 | Portion |
| 42 | Portion |
| 44 | Flange |
| 46 | Side |
| 47 | End |
| 48 | surface area |
| 49 | Clip |
| 50 | Wire |
| 51 | carrier element |
| 52 | Clip |
| 53 | Portion |

We claim:

1. A bearing assembly comprising:
a bearing ring; and
at least one brush assembly including a first part fixed to the bearing ring, a second part fixed to the first part and having a first, face side and a second side, the second side being opposite to the first side, and a conductive brush fixed to the second part;
wherein the first part abuts against the first side of the second part and the first part abuts against the second side of the second part.

2. The bearing assembly according to claim 1, wherein the first part includes at least a first radially-extending portion abutting against a face side of the bearing ring.

3. The bearing assembly according to claim 2, wherein the first radially-extending portion abuts against the first, face side of the second part.

4. The bearing assembly according to claim 2, wherein the first part further includes at least a second radially-extending portion connected with the first radially-extending portion and abutting against the second side of the second part.

5. The bearing assembly according to claim 1, wherein the first part is integrally formed and consists of sheet metal and/or the second part is integrally formed and consists of sheet metal.

6. The bearing assembly according to claim 1, wherein the bearing ring has a recess and the first part is fixed to the bearing ring by the recess of the bearing ring and/or the second part is fixed to the bearing by the recess of the bearing ring.

7. The bearing assembly according to claim 6, wherein the recess is a groove and the first part has a collar portion extending into the groove and contacting a surface of the groove so as to fix the first part to the bearing ring.

8. The bearing assembly according to claim 1, wherein the second part includes at least a first fixation means, the first fixation means at least partially fixing the conductive brush to the second part, a first radially-extending portion having a greater radial extent than the first fixation means and a second radially-extending portion located radially outwardly of and spaced axially from the first radially-extending portion.

9. A device with a housing and a bearing assembly according to claim 1, wherein the brush assembly abuts against the housing.

10. A method for assembling a bearing assembly according to claim 1, the method including the steps of:
providing a brush assembly including a first part and a second part having a first, face side and an opposing second side;
positioning the face side of the second part of the brush assembly into contact with the first part of the brush assembly; and
bending at least a portion of the first part of the brush assembly radially inwardly so as to contact the second side of the second part of the brush assembly.
